(19) United States
(12) Patent Application Publication
(10) Pub. No.: US 2014/0168204 A1
(43) Pub. Date: Jun. 19, 2014

(54) MODEL BASED VIDEO PROJECTION

(71) Applicant: MICROSOFT CORPORATION, Redmond, WA (US)

(72) Inventors: Zhengyou Zhang, Bellevue, WA (US); Qin Cai, Clyde Hill, WA (US); Philip A. Chou, Bellevue, WA (US)

(73) Assignee: MICROSOFT CORPORATION, Redmond, WA (US)

(21) Appl. No.: 13/712,998

(22) Filed: Dec. 13, 2012

(51) Int. Cl. G06T 13/20

(52) U.S. Cl. CPC G06T 13/20
USPC 345/419

(57) ABSTRACT

A method, system, and computer-readable storage media for model based video projection are provided herein. The method includes tracking an object within a video based on a three-dimensional parametric model via a computing device and projecting the video onto the three-dimensional parametric model. The method also includes updating a texture map corresponding to the object within the video and rendering a three-dimensional video of the object from any of a number of viewpoints by loosely coupling the three-dimensional parametric model and the updated texture map.

### BACKGROUND

Videos are useful for many applications, including communication applications, gaming applications, and the like. According to current techniques, a video can only be viewed from the viewpoint from which it was captured. However, for some applications, it may be desirable to view a video from a viewpoint other than the one from which it was captured.

### SUMMARY

The following presents a simplified summary of the innovation in order to provide a basic understanding of some aspects described herein. This summary is not an extensive overview of the claimed subject matter. It is intended neither to identify key nor critical elements of the claimed subject matter nor to delineate the scope of the subject innovation. Its sole purpose is to present some concepts of the claimed subject matter in a simplified form as a prelude to the more detailed description that is presented later.

An embodiment provides a method for model based video projection. The method includes tracking an object within a video based on a three-dimensional parametric model via a computing device and projecting the video onto the three-dimensional parametric model. The method also includes updating a texture map corresponding to the object within the video and rendering a three-dimensional video of the object from any of a number of viewpoints by loosely coupling the three-dimensional parametric model and the updated texture map.

Another embodiment provides a system for model based video projection. The system includes a processor that is configured to execute stored instructions and a system memory. The system memory includes code configured to track an object within a video by deforming a three-dimensional parametric model to fit the video and project the video onto the three-dimensional parametric model. The code is also configured to update a texture map corresponding to the object within the video by updating regions of the texture map that are observed from the video and render a three-dimensional video of the object from any of a number of viewpoints by loosely coupling the three-dimensional parametric model and the updated texture map.

Another embodiment provides one or more computer-readable storage media including a number of instructions that, when executed by a processor, cause the processor to track an object within a video based on a three-dimensional parametric model, project the video onto the three-dimensional parametric model, and update a texture map corresponding to the object within the video. The instructions also cause the processor to render a three-dimensional video of the object from any of a number of viewpoints by loosely coupling the three-dimensional parametric model and the updated texture map.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of a networking environment that may be used to implement a method and system for model based video projection;

FIG. 2 is a block diagram of a computing environment that may be used to implement a method and system for model based video projection;

FIG. 3 is a process flow diagram illustrating a model based video projection technique; and

FIG. 4 is a process flow diagram showing a method for model based video projection.

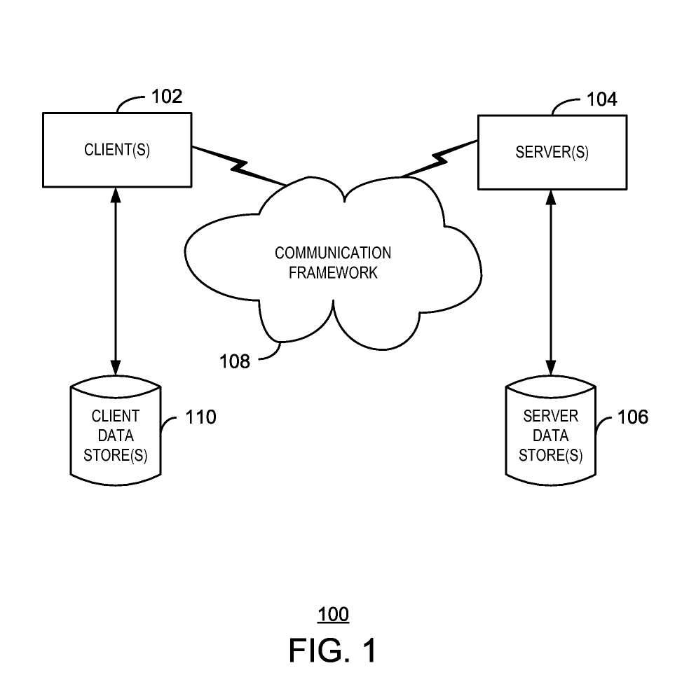

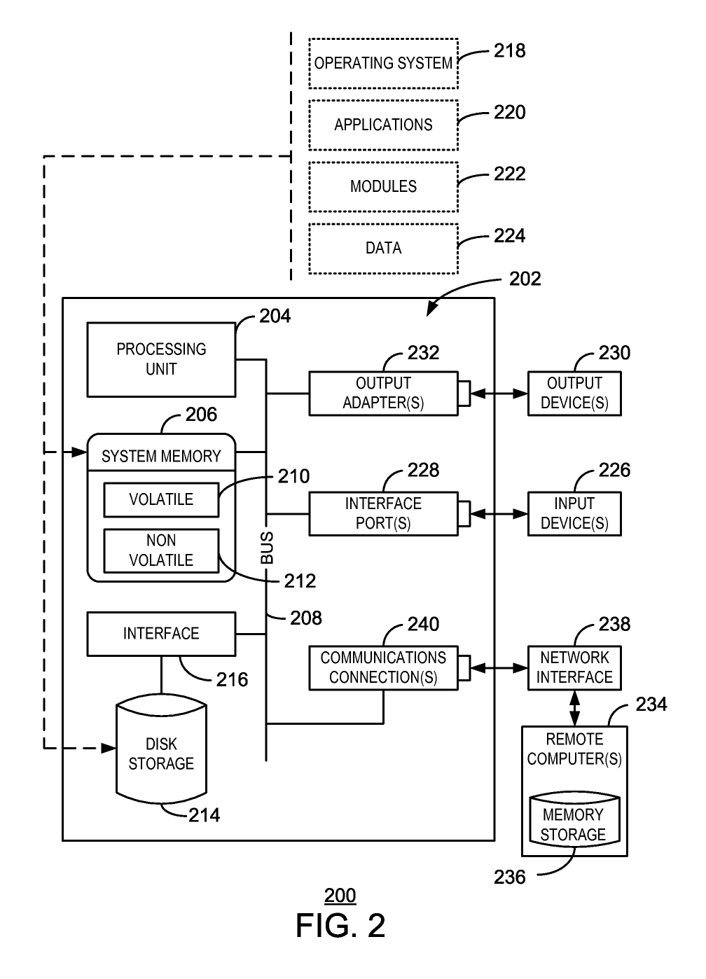

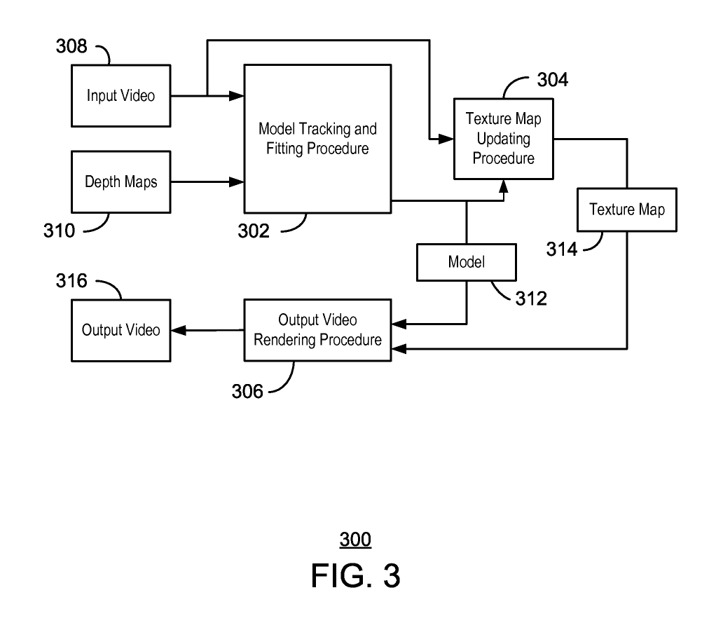

The same numbers are used throughout the disclosure and figures to reference like components and features. Numbers in the 100 series refer to features originally found in FIG. 1, numbers in the 200 series refer to features originally found in FIG. 2, numbers in the 300 series refer to features originally found in FIG. 3, and so on.

### DETAILED DESCRIPTION

As discussed above, a video can typically only be viewed from the viewpoint from which it was captured. However, it may be desirable to view a video from a viewpoint other than the one from which it was captured. Thus, embodiments described herein set forth model based video projection techniques that allow a video or, more specifically, an object of interest in a video to be viewed from multiple different viewpoints. This may be accomplished by estimating the three-dimensional structure of a remote scene and projecting a live video onto the three-dimensional structure such that the live video can be viewed from multiple viewpoints. The three-dimensional structure of the remote scene may be estimated using a parametric model.

In various embodiments, the model based video projection techniques described herein are used to view a face of a person from multiple viewpoints. According to such embodiments, the parametric model may be a generic face model. The ability to view a face from multiple viewpoints may be useful for many applications, including video conferencing applications and gaming applications, for example.

The model based video projection techniques described herein may allow for loose coupling between the three-dimensional parametric model and the video including the object of interest. In various embodiments, a complete three-dimensional video of the object of interest may be rendered even if the input video only includes partial information for the object of interest. In addition, the model based video projection techniques described herein provide for temporal consistency in geometry, as well as post-processing such as noise removal and hole filling. For example, temporal consistency in geometry may be maintained by mapping the object of interest within the video to the three-dimensional parametric model and the texture map over time. Noise removal may be accomplished by identifying the object of interest within the input video and discarding all data within the input video that does not correspond to the object of interest. Furthermore, hole filling may be accomplished by using the three-dimensional parametric model and the texture map to fill in or estimate regions of the object of interest that are not observed from the video.

As a preliminary matter, some of the figures describe concepts in the context of one or more structural components, variously referred to as functionality, modules, features, elements, etc. The various components shown in the figures can be implemented in any manner, for example, by software, hardware (e.g., discrete logic components, etc.), firmware, and so on, or any combination of these implementations. In one embodiment, the various components may reflect the use of corresponding components in an actual implementation. In other embodiments, any single component illustrated in the figures may be implemented by a number of actual components. The depiction of any two or more separate components in the figures may reflect different functions performed by a single actual component. FIG. 1, discussed below, provides details regarding one system that may be used to implement the functions shown in the figures.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into plural component blocks, and certain blocks can be performed in an order that differs from that which is illustrated herein, including a parallel manner of performing the blocks. The blocks shown in the flowcharts can be implemented by software, hardware, firmware, manual processing, and the like, or any combination of these implementations. As used herein, hardware may include computer systems, discrete logic components, such as application specific integrated circuits (ASICs), and the like, as well as any combinations thereof.

As to terminology, the phrase “configured to” encompasses any way that any kind of functionality can be constructed to perform an identified operation. The functionality can be configured to perform an operation using, for instance, software, hardware, firmware and the like, or any combinations thereof.

The term “logic” encompasses any functionality for performing a task. For instance, each operation illustrated in the flowcharts corresponds to logic for performing that operation. An operation can be performed using, for instance, software, hardware, firmware, etc., or any combinations thereof.

As utilized herein, terms “component,” “system,” “client” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware.

By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any tangible computer-readable storage device, or media.

Computer-readable storage media include storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media (i.e., not storage media) may additionally include communication media such as transmission media for communication signals and the like.

Moreover, the word “exemplary” is used herein to mean serving as an example, instance, or illustration. Any aspect or design described herein as “exemplary” is not necessarily to be construed as preferred or advantageous over other aspects or designs.

In order to provide context for implementing various aspects of the claimed subject matter, FIGS. 1-2 and the following discussion are intended to provide a brief, general description of a computing environment in which the various aspects of the subject innovation may be implemented. For example, a method and system for model based video projection can be implemented in such a computing environment. While the claimed subject matter has been described above in the general context of computer-executable instructions of a computer program that runs on a local computer or remote computer, those of skill in the art will recognize that the subject innovation also may be implemented in combination with other program modules. Generally, program modules include routines, programs, components, data structures, etc., that perform particular tasks or implement particular abstract data types.

Moreover, those of skill in the art will appreciate that the subject innovation may be practiced with other computer system configurations, including single-processor or multi-processor computer systems, minicomputers, mainframe computers, as well as personal computers, hand-held computing devices, microprocessor-based or programmable consumer electronics, and the like, each of which may operatively communicate with one or more associated devices. The illustrated aspects of the claimed subject matter may also be practiced in distributed computing environments wherein certain tasks are performed by remote processing devices that are linked through a communications network. However, some, if not all, aspects of the subject innovation may be practiced on stand-alone computers. In a distributed computing environment, program modules may be located in local or remote memory storage devices.

FIG. 1 is a block diagram of a networking environment 100 that may be used to implement a method and system for model based video projection. The networking environment 100 includes one or more client(s) 102. The client(s) 102 can be hardware and/or software (e.g., threads, processes, or computing devices). The networking environment 100 also includes one or more server(s) 104. The server(s) 104 can be hardware and/or software (e.g., threads, processes, or computing devices). The servers 104 can house threads to perform search operations by employing the subject innovation, for example.

One possible communication between a client 102 and a server 104 can be in the form of a data packet adapted to be transmitted between two or more computer processes. The networking environment 100 includes a communication framework 108 that can be employed to facilitate communications between the client(s) 102 and the server(s) 104. The client(s) 102 are operably connected to one or more client data store(s) 110 that can be employed to store information local to the client(s) 102. The client data store(s) 110 may be stored in the client(s) 102, or may be located remotely, such as in a cloud server. Similarly, the server(s) 104 are operably connected to one or more server data store(s) 106 that can be employed to store information local to the servers 104.

FIG. 2 is a block diagram of a computing environment that may be used to implement a method and system for model based video projection. The computing environment 200 includes a computer 202. The computer 202 includes a processing unit 204, a system memory 206, and a system bus 208. The system bus 208 couples system components including, but not limited to, the system memory 206 to the processing unit 204. The processing unit 204 can be any of various available processors. Dual microprocessors and other multiprocessor architectures also can be employed as the processing unit 204.

The system bus 208 can be any of several types of bus structures, including the memory bus or memory controller, a peripheral bus or external bus, or a local bus using any variety of available bus architectures known to those of ordinary skill in the art. The system memory 206 is computer-readable storage media that includes volatile memory 210 and non-volatile memory 212. The basic input/output system (BIOS), containing the basic routines to transfer information between elements within the computer 202, such as during start-up, is stored in non-volatile memory 212. By way of illustration, and not limitation, non-volatile memory 212 can include read-only memory (ROM), programmable ROM (PROM), electrically-programmable ROM (EPROM), electrically-erasable programmable ROM (EEPROM), or flash memory.

Volatile memory 210 includes random access memory (RAM), which acts as external cache memory. By way of illustration and not limitation, RAM is available in many forms, such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 202 also includes other computer-readable storage media, such as removable/non-removable, volatile/non-volatile computer storage media. FIG. 2 shows, for example, a disk storage 214. Disk storage 214 includes, but is not limited to, devices like a magnetic disk drive, floppy disk drive, tape drive, Jaz drive, Zip drive, LS-100 drive, flash memory card, or memory stick.

In addition, disk storage 214 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 214 to the system bus 208, a removable or non-removable interface is typically used, such as interface 216.

It is to be appreciated that FIG. 2 describes software that acts as an intermediary between users and the basic computer resources described in the computing environment 200. Such software includes an operating system 218. The operating system 218, which can be stored on disk storage 214, acts to control and allocate resources of the computer 202.

System applications 220 take advantage of the management of resources by the operating system 218 through program modules 222 and program data 224 stored either in system memory 206 or on disk storage 214. It is to be appreciated that the claimed subject matter can be implemented with various operating systems or combinations of operating systems.

A user enters commands or information into the computer 202 through input devices 226. Input devices 226 include, but are not limited to, a pointing device (such as a mouse, trackball, stylus, or the like), a keyboard, a microphone, a gesture or touch input device, a voice input device, a joystick, a satellite dish, a scanner, a TV tuner card, a digital camera, a digital video camera, a web camera, or the like. The input devices 226 connect to the processing unit 204 through the system bus 208 via interface port(s) 228. Interface port(s) 228 include, for example, a serial port, a parallel port, a game port, and a universal serial bus (USB). Output device(s) 230 may also use the same types of ports as input device(s) 226. Thus, for example, a USB port may be used to provide input to the computer 202 and to output information from the computer 202 to an output device 230.

An output adapter 232 is provided to illustrate that there are some output devices 230 like monitors, speakers, and printers, among other output devices 230, which are accessible via the output adapters 232. The output adapters 232 include, by way of illustration and not limitation, video and sound cards that provide a means of connection between the output device 230 and the system bus 208. It can be noted that other devices and/or systems of devices provide both input and output capabilities, such as remote computer(s) 234.

The computer 202 can be a server hosting an event forecasting system in a networking environment, such as the networking environment 100, using logical connections to one or more remote computers, such as remote computer(s) 234. The remote computer(s) 234 may be client systems configured with web browsers, PC applications, mobile phone applications, and the like. The remote computer(s) 234 can be a personal computer, a server, a router, a network PC, a workstation, a microprocessor based appliance, a mobile phone, a peer device or other common network node and the like, and typically includes many or all of the elements described relative to the computer 202. For purposes of brevity, the remote computer(s) 234 is illustrated with a memory storage device 236. Remote computer(s) 234 is logically connected to the computer 202 through a network interface 238 and then physically connected via a communication connection 240.

Network interface 238 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 240 refers to the hardware/software employed to connect the network interface 238 to the system bus 208. While communication connection 240 is shown for illustrative clarity inside computer 202, it can also be external to the computer 202. The hardware/software for connection to the network interface 238 may include, for example, internal and external technologies such as mobile phone switches, modems including regular telephone grade modems, cable modems and DSL modems, ISDN adapters, and Ethernet cards.

FIG. 3 is a process flow diagram illustrating a model based video projection technique 300. In various embodiments, the model based video projection technique 300 is executed by a computing device. For example, the model based video projection technique 300 may be implemented within the networking environment 100 and/or the computing environment 200 discussed above with respect to FIGS. 1 and 2, respectively. The model based video projection technique 300 may include a model tracking and fitting procedure 302, a texture map updating procedure 304, and an output video rendering procedure 306, as discussed further below.

The model tracking and fitting procedure 302 may include deforming a three-dimensional parametric model based on an input video 308 and, optionally, one or more depth maps 310 corresponding to the input video 308. Specifically, the three-dimensional parametric model may be aligned with an object of interest within the input video 308. The three-dimensional parametric model may then be used to track the object within the input video 308 by fitting the three-dimensional parametric model to the object within the input video 308 and, optionally, the one or more depth maps 310. The updated three-dimensional parametric model 312 may then be used for the output video rendering procedure 306.

According to the texture map updating procedure 304, the input video 308 and the output of the model tracking and fitting procedure 302 may be used to update a texture map corresponding to the object of interest within the input video 308. Specifically, the object of interest within the video may be mapped to the texture map, and regions of the texture map corresponding to the object that are observed from the video may be updated. In other words, if a texture region is observed in the video frame, the value of the texture region is updated. Otherwise, the value of the texture region remains unchanged.

In various embodiments, the texture map is updated over time such that every viewpoint of the object of interest that is observed from the video is reflected within the updated texture map 314. The updated texture map 314 may then be saved within the computing device, and may be used for the output video rendering procedure 306 at any point in time.

The output video rendering procedure 306 may generate an output video 316 based on the updated three-dimensional parametric model 312 and the updated texture map 314. The output video 316 may be a three-dimensional video of the object of interest within the input video 308, rendered from any desired viewpoint. For example, the output video 316 may be rendered from a viewpoint specified by a user of the computing device.

The process flow diagram of FIG. 3 is not intended to indicate that the model based video projection technique 300 is to include all of the steps shown in FIG. 3, or that all of the steps are to be executed in any particular order. Further, any number of additional steps not shown in FIG. 3 may be included within the model based video projection technique 300, depending on the details of the specific implementation.

The model based video projection technique 300 of FIG. 3 may be used for any of a variety of applications. The model based video projection technique 300 may be particularly useful for rendering a three-dimensional video of any non-rigid object for which only partial information can be obtained from an input video including the non-rigid object. For example, the model based video projection technique 300 may be used to render a three-dimensional video of a face or entire body of a person for video conferencing or gaming applications. As another example, the model based video projection technique 300 may be used to render a three-dimensional video of a particular object of interest, such as a person or animal, for surveillance or monitoring applications.

In various embodiments, a regularized maximum likelihood deformable model fitting (DMF) algorithm may be used for the model tracking and fitting procedure 302 described with respect to the model based video projection technique 300 of FIG. 3. Specifically, the regularized maximum likelihood DMF algorithm may be used in conjunction with a commodity depth camera to track an object of interest within a video and fit a model to the object of interest. For ease of discussion, the object of interest may be described herein as being a human face. However, it is to be understood that the object of interest can be any object within a video that is of interest to a user.

A linear deformable model may be used to represent the possible variations of a human face. The linear deformable model may be constructed by an artist, or may be constructed semi-automatically by a computing device. The linear deformable model may be constructed as a set of K vertices P and a set of facets F. Each vertex pₖεP is a point in [symbol] ³, and each facet fεF is a set of three of more vertices from the set P. Within the linear deformable model, all facets have exactly three vertices. In addition, the linear deformable model is augmented with two artist-defined deformation matrices, including a static deformation matrix B and an action deformation matrix A. According to weighting vectors s and r, the two matrices transform the mesh linearly into a target model Q as shown below in Eq. (1).

$$[ \begin{matrix}{q}_{1} \\ ⋮ \\ {q}_{K}\end{matrix} ] = [ \begin{matrix}{p}_{1} \\ ⋮ \\ {p}_{K}\end{matrix} ] + A [ \begin{matrix}{r}_{1} \\ ⋮ \\ {r}_{N}\end{matrix} ] + B [ \begin{matrix}{s}_{1} \\ ⋮ \\ {s}_{M}\end{matrix} ] \qquad ( 1 )$$

In Eq. (1), M and N are the number of deformations in B and A, and αₘ≦sₘ≦βₘ, m=1, . . . , M and θₙ≦rₙ≦φₙ, n=1, . . . N are ranges specified by the artist. The static deformations in B are characteristic to a particular face, such as enlarging the distance between eyes or extending the chin, for example. The action deformations include opening the mouth or raising the eyebrows, for example.

Let P represent the vertices of the model, and let G represent the three-dimensional points acquired from the depth camera. The rotation R and translation t between the model and the depth camera may be computed, as well as the deformation parameters r and s. The problem may be formulated as discussed below.

It is assumed that, in a certain iteration, a set of point correspondences between the model and the depth image is available. For each correspondence (pₖ,gₖ),gₖεG, Eq. (2) is obtained as shown below.

R(pₖ+Aₖr+Bₖs)+t=gₖ+xₖ (2)

According to Eq. (2), Aₖ and Bₖ represent the three rows of A and B that correspond to vertex k, and xₖ is the depth sensor noise, which can be assumed to follow a zero mean Gaussian distribution N(0,Σₓ_{ₖ}). The maximum likelihood solution of the unknowns R, t, r, and s can be derived by minimizing Eq. (3).

$${J}_{2} ( R , t , r , s ) = \frac{1}{K} {\sum }_{k = 1}^{K} {x}_{k}^{T} {Σ}_{{x}_{k}}^{- 1} {x}_{k} \qquad ( 3 )$$

In Eq. (3), xₖ=R(pₖ+Aₖr+Bₖs)+t−gₖ. Further, r and s are subject to inequality constraints, namely, αₘ≦sₘ≦βₘ, m=1, . . . , M and θₙ≦rₙ≦θₙ, n=1, . . . N. In some embodiments, additional regularization terms may be added to the above optimization problem.

One possible variation is to substitute the point-to-point distance with point-to-plane distance. The point-to-plane distance allows the model to slide tangentially to the surface, which speeds up convergence and makes it less likely to get stuck in local minima. Distance to the plane can be computed using the surface normal, which can be computed from the model based on the current iteration's head pose. Let the surface normal of point pₖ in the model coordinate be nₖ. The point-to-plane distance can be computed as shown below in Eq. (4).

yₖ=(Rnₖ)^{T}xₖ (4)

The maximum likelihood solution is then obtained by minimizing Eq. (5).

$${J}_{2} ( R , t , r , s ) = \frac{1}{K} {\sum }_{k = 1}^{K} \frac{{y}_{k}^{2}}{{σ}_{{y}_{k}}^{2}} \qquad ( 5 )$$

In Eq. (5), σ_{y}_{ₖ}²=(Rnₖ)^{T}Σₓ_{ₖ}(Rnₖ), and αₘ≦sₘ≦βₘ, m=1, . . . , M and θₙ≦rₙ≦φₙ, n=1, . . . N.

Given the correspondence pairs (pₖ, gₖ), since both the point-to-point and the point-to-plane distances are nonlinear, a solution that solves for r, s and R, t in an iterative fashion may be used.

In order to generate an iterative solution for the identity noise covariance matrix, it may first be assumed that the depth sensor noise covariance matrix is a scaled identity matrix, i.e., Σₓ_{ₖ}=σ²I₃, where I₃ is a 3×3 identity matrix. Let \tilde{R}=R⁻¹, \tilde{t}=\tilde{R}t. Further, let yₖ be as shown below in Eq. (6).

yₖ=\tilde{R}xₖ=pₖ+Aₖr+BₖS+\tilde{t}−\tilde{R}gₖ (6)

Since xₖ^{T}xₖ=(Ryₖ)^{T} (Ryₖ)=yₖ^{T} yₖ, the likelihood function can be written as shown below in Eq. (7).

$${J}_{1} ( R , t , r , s ) = \frac{1}{K {σ}^{2}} {\sum }_{k = 1}^{K} {x}_{k}^{T} {x}_{k} = \frac{1}{K {σ}^{2}} {\sum }_{k = 1}^{K} {y}_{k}^{T} {y}_{k} \qquad ( 7 )$$

Similarly, for point-to-plane distance, since yₖ=(Rnₖ)^{T} xₖ=nₖ^{T}R^{T}Ryₖ=nₖ^{T}yₖ, and σ_{y}_{ₖ}²=(Rnₖ)^{T} Σₓ_{ₖ}(Rnₖ)=σ⁻², Eq. (8) is obtained as shown below.

$${J}_{2} ( R , t , r , s ) = \frac{1}{K {σ}^{2}} {\sum }_{k = 1}^{K} {y}_{k}^{T} {N}_{k} {y}_{k} \qquad ( 8 )$$

In Eq. (8), Nₖ=nₖnₖ^{T}.

The rotation matrix \tilde{R} may be decomposed into an initial rotation matrix \tilde{R}₀ and an incremental rotation matrix Δ\tilde{R}, where the initial rotation matrix can be the rotation matrix of the head in the previous frame, or an estimation of \tilde{R} obtained in another algorithm. In other words, let \tilde{R}=Δ\tilde{R}\tilde{R}₀. Since the rotation angle of the incremental rotation matrix is small, the rotation angle may be linearized as shown below in Eq. (9).

$$Δ \tilde{R} \approx [ \begin{matrix}1 & - {ω}_{3} & {ω}_{2} \\ {ω}_{3} & 1 & - {ω}_{1} \\ - {ω}_{2} & {ω}_{1} & 1\end{matrix} ] \qquad ( 9 )$$

In Eq. (9), ω=[ω₁, ω₂, ω₃]^{T} is the corresponding small rotation vector. Further, let qₖ=\tilde{R}₀gₖ=[qₖ₁,qₖ₂,qₖ]^{T}. The variable yₖ can be written in the form of unknowns r, s, \tilde{t}, and ω as shown below in Eq. (10).

$$\begin{matrix}{y}_{k} = {p}_{k} + {A}_{k} r + {B}_{k} s + \tilde{t} - Δ \tilde{R} {q}_{k} \\ \approx ( {p}_{k} - {q}_{k} ) + [ {A}_{k} , {B}_{k} , {I}_{3} , [ {q}_{k} ] x ] [ \begin{matrix}r \\ s \\ \tilde{t} \\ ω\end{matrix} ]\end{matrix} \qquad ( 10 )$$

In Eq. (10), [qₖ]x is the skew-symmetric matrix of qₖ, as shown below in Eq. (11).

$$[ {q}_{k} ] x = [ \begin{matrix}0 & - {q}_{k 3} & {q}_{k 2} \\ {q}_{k 3} & 0 & - {q}_{k 1} \\ - {q}_{k 2} & {q}_{k 1} & 0\end{matrix} ] \qquad ( 11 )$$

Let Hₖ=[Aₖ, Bₖ, I₃, [qₖ]x], uₖ=pₖ−qₖ, and let z=[r^{T}, s^{T}, \tilde{t}^{T}, ω^{T}]^{T}. Eq. (12) may then be obtained as shown below.

yₖ=uₖ+HₖZ (12)

Therefore, Eqs. (13) and (14) can be obtained as shown below.

$$\begin{matrix}\begin{matrix}{J}_{1} = \frac{1}{K {σ}^{2}} {\sum }_{k = 1}^{K} {y}_{k}^{T} {y}_{k} \\ = \frac{1}{K {σ}^{2}} {\sum }_{k = 1}^{K} {( {u}_{k} + {H}_{k} z )}^{T} ( {u}_{k} + {H}_{k} z )\end{matrix} & ( 13 ) \\ \begin{matrix}{J}_{2} = \frac{1}{K {σ}^{2}} {\sum }_{k = 1}^{K} {y}_{k}^{T} {N}_{k} {y}_{k} \\ = \frac{1}{K {σ}^{2}} {\sum }_{k = 1}^{K} {( {u}_{k} + {H}_{k} z )}^{T} {N}_{k} ( {u}_{k} + {H}_{k} z )\end{matrix} & ( 14 )\end{matrix}$$

Both likelihood functions are quadratic with respect to z. Since there are linear constraints on the range of values for r and s, the minimization problem can be solved with quadratic programming.

The rotation vector ω is an approximation of the actual incremental rotation matrix. One can simply insert Δ\tilde{R}\tilde{R}₀ to the position of \tilde{R}₀ and repeat the above optimization process until it converges.

A solution for the arbitrary noise covariance matrix may also be generated. When the sensor noise covariance matrix is arbitrary, an iterative solution may be obtained. Since yₖ=\tilde{R}xₖ, Σ_{y}_{ₖ}=\tilde{R}Σₓ_{ₖ}\tilde{R}^{T}. A feasible solution can be obtained if \tilde{R} is replaced with its estimation \tilde{R}₀ as shown below in Eq. (15).

Σ_{y}_{ₖ}≈\tilde{R}₀Σₓ^{k}\tilde{R}₀^{T} (15)

The solution to Eq. (16) is known for the current iteration. Subsequently, Eqs. (16) and (17) may be obtained.

$$\begin{matrix}\begin{matrix}{J}_{1} = \frac{1}{K} {\sum }_{k = 1}^{K} {y}_{k}^{T} {Σ}_{{y}_{k}}^{- 1} {y}_{k} \\ = \frac{1}{K} {\sum }_{k = 1}^{K} {( {u}_{k} + {H}_{k} z )}^{T} {Σ}_{{y}_{k}}^{- 1} ( {u}_{k} + {H}_{k} z )\end{matrix} & ( 16 ) \\ \begin{matrix}{J}_{2} = \frac{1}{K} {\sum }_{k = 1}^{K} \frac{{y}_{k}^{T} {N}_{k} {y}_{k}}{{n}_{k}^{T} {Σ}_{{y}_{k}} {n}_{k}} \\ = \frac{1}{K} {\sum }_{k = 1}^{K} \frac{{( {u}_{k} + {H}_{k} z )}^{T} {N}_{k} ( {u}_{k} + {H}_{k} z )}{{n}_{k}^{T} {Σ}_{{y}_{k}} {n}_{k}}\end{matrix} & ( 17 )\end{matrix}$$

The quadratic functions with respect to z can be solved via quadratic programming. Again, the minimization may be repeated until convergence by inserting Δ\tilde{R}\tilde{R}₀ to the position of \tilde{R}₀ in each iteration.

For the model tracking and fitting procedure 302 described herein, the above maximum likelihood DMF framework is applied differently in two stages. During the initialization stage, the goal is to fit the generic deformable model to an arbitrary person. It may be assumed that a set of L (L≦10 in the current implementation) neutral face frames is available. The action deformation vector r is assumed to be zero. The static deformation vector s and the face rotations and translations are jointly solved as follows.

The correspondences are denoted as (pₗₖ,gₗₖ), where l=1, . . . , L represents the frame index. Assume in the previous iteration that \tilde{R}ₗ₀ is the rotation matrix for frame l. Let qₗₖ=\tilde{R}ₗ₀gₗₖ and Hₗₖ=[Bₖ, 0, 0, . . . , I₃, [gₗₖ]x, . . . , 0, 0], where 0 represents a 3×3 zero matrix. Let uₗₖ=pₗₖ−qₗₖ, and the unknown vector z=[s^{T}, \tilde{t}₁^{T}, ω₁^{T}, . . . , \tilde{t}_{L}^{T}, ω_{L}^{T}]^{T}. Following Eqs. (16) and (17), the overall likelihood function may be rewritten as shown below in Eqs. (18) and (19).

$$\begin{matrix}{J}_{init 1} = \frac{1}{KL} {\sum }_{l = 1}^{L} {\sum }_{k = 1}^{K} {( {u}_{lk} + {H}_{lk} z )}^{T} {Σ}_{{y}_{lk}}^{- 1} ( {u}_{lk} + {H}_{lk} z ) & ( 18 ) \\ {J}_{init 2} = \frac{1}{KL} {\sum }_{l = 1}^{L} {\sum }_{k = 1}^{K} \frac{{( {u}_{lk} + {H}_{lk} z )}^{T} {N}_{lk} ( {u}_{lk} + {H}_{lk} z )}{{n}_{lk}^{T} {Σ}_{{y}_{lk}} {n}_{lk}} & ( 19 )\end{matrix}$$

According to Eqs. (18) and (19), nₗₖ is the surface normal vector for point pₗₖ, Nₗₖ=nₗₖnₗₖ^{T}, and Σ_{y}_{ₗₖ}≈\tilde{R}ₗ₀Σₓ_{ₗₖ}\tilde{R}ₗ₀^{T}. In addition, xₗₖ is the sensor noise for depth input gₗₖ.

The point-to-point and point-to-plane likelihood functions are used jointly in the current implementation. A selected set of point correspondences is used for Jᵢₙₜ₁, and another selected set of point correspondences is used for Jᵢₙᵢₜ₂. The overall target function is the linear combination shown below in Eq. (20).

Jᵢₙᵢₜ=λ₁Jᵢₙᵢₜ₁+λ₂Jᵢₙᵢₜ₂ (20)

In Eq. (20), λ₁ and λ₂ are the weights between the two functions. The optimization is conducted through quadratic programming.

After the static deformation vector s has been initialized, the face is tracked frame by frame. The action deformation vector r, face rotation R, and translation t may be estimated, while keeping s fixed. In some embodiments, additional regularization terms may also be added in the target function to further improve the results.

A natural assumption is that the expression change between the current frame and the previous frame is small. According to embodiments described herein, if the previous frame's face action vector is r^{t-1}, the l₂ regularization term may be added according to Eq. (21).

J_{track}=λA₁J₁+λ₂J₂+λ₃∥r−r^{t-1}∥₂² (21)

In Eq. (21), J₁ and J₂ follow Eqs. (16) and (17). Similar to the initialization process, J₁ and J₂ use different sets of feature points. The term ∥r−r^{t-1}∥₂²=(r−r^{t-1})^{T}(r−r^{t-1}) is the squared l₂ norm of the difference between the two vectors.

The r vector represents a particular action a face can perform. Since it is difficult for a face to perform all actions simultaneously, the r vector may be sparse in general. Thus, an additional l₁ regularization term may be imposed, as shown below in Eq. (22).

J_{track}=λ₁J₁+λ₂J₂+λ₃∥r−r^{t-1}∥₂²+λ₄∥r∥₁ (22)

In Eq. (22), ∥r∥₁=Σₙ₌₁^{N}|rₙ| is the l₁ norm. This regularized target function is now in the form of an l₁-regularized least squares problem, which can be reformulated as a convex quadratic program with linear inequality constraints. This can be solved with quadratic programming methods.

Multiple neutral face frames may be used for model initialization. The likelihood function Jᵢₙᵢₜ contains both point-to-point and point-to-plane terms, as shown in Eq. (20). For the point-to-plane term Jᵢₙᵢₜ₂, the corresponding point pairs are derived by the standard procedure of finding the closest point on the depth map from the vertices on the deformable model. However, the point-to-plane term alone may not be sufficient, since the depth maps may be noisy and the vertices of the deformable model can drift tangentially, leading to unnatural faces.

For each initialization frame, face detection and alignment may first be performed on the texture image. The alignment algorithm may provide a number of landmark points of the face, which are assumed to be consistent across all the frames. These landmark points are separated into four categories. The first category includes landmark points representing eye corners, mouth corners, and the like. Such landmark points have clear correspondences pₗₖ in the linear deformable face model. Given the calibration information between the depth camera and the texture camera, the landmark points can simply be projected to the depth image to find the corresponding three-dimensional world coordinate gₗₖ.

The second category includes landmark points on the eyebrows and upper and lower lips. The deformable face model has a few vertices that define eyebrows and lips, but the vertices do not all correspond to the two-dimensional feature points provided by the alignment algorithm. In order to define correspondences, the following procedure may be performed. First, the previous iteration's head rotation R₀ and translation t₀ may be used to project the face model vertices pₗₖ of the eyebrows and upper and lower lips to the texture image vₗₖ. Second, the closest point on the curve defined by the alignment results to vₗₖ may be found and may be defined as v′ₗₖ. Third, v′ₗₖ may be back projected to the depth image to find its three-dimensional world coordinate gₗₖ.

The third category includes landmark points surrounding the face, which may be referred to as silhouette points. The deformable model also has vertices that define these boundary points, but there is no correspondence between them and the alignment results. Moreover, when back projecting the silhouette points to the three-dimensional world coordinate, the silhouette points may easily hit a background pixel in the depth image. For these points, a procedure that is similar to the procedure that is performed for the second category of landmark points may be performed. However, the depth axis may be ignored when computing the distance between pₗₖ and gₗₖ. Furthermore, the fourth category of landmark points includes all of the white points, which are not used in the current implementation.

During tracking, both the point-to-point and point-to-plane likelihood terms may be used, with additional regularization as shown in Eq. (22). The point-to-plane term is computed similarly as that during model initialization. Feature points detected and tracked from the texture images may be relied on to define the point correspondences.

The feature points are detected in the texture image of the previous frame using the Harris corner detector. The feature points are then tracked to the current frame by matching patches surrounding the points using cross correlation. In some cases, however, the feature points may not correspond to any vertices in the deformable face model. Given the previous frame's tracking results, the feature points are first represented with their barycentric coordinates. Specifically, for two-dimensional feature point pair vₖ^{t-1} and vₖ^{t}, the parameters n₁, n₂, and n₃ are obtained such that Eq. (23) holds.

vₖ^{t-1}=n₁\hat{p}ₖ_{₁}^{t-1}+n₂\hat{p}ₖ_{₂}^{t-1}+n₃\hat{p}ₖ_{₃}^{t-1} (23)

In Eq. (23), n₁+n₂+n₃=1, and \hat{p}ₖ_{₁}^{t-1}, \hat{p}ₖ_{₂}^{t-1}, and \hat{p}ₖ_{₃}^{t-1} are the two-dimensional projections of the deformable model vertices pₖ_{₁}, pₖ_{₂}, and pₖ_{₃} onto the previous frame. Similarly the Eq. (2), Eq. (24) may be obtained as shown below.

RΣᵢ₌₁³(pₖ+Aₖr+Bₖs)+t=gₖ+xₖ (24)

In Eq. (24), gₖ is the back projected three-dimensional world coordinate of the two-dimensional feature point vₖ^{t}. Let p̅ₖ=Σᵢ₌₁³nᵢpₖ_{ᵢ}, Āₖ=Σᵢ₌₁³nᵢAₖ_{ᵢ}, and B̅ₖ=Σᵢ₌₁³nᵢBₖ_{ᵢ}. Eq. (24) will be identical form as Eq. (2). Therefore, tracking is still solved using Eq. (22).

Due to the potential of strong noise in the depth sensor, it may be desirable to model the actual sensor noise with the correct Σₓ_{ₖ} instead of using an identity matrix for approximation. The uncertainty of the three-dimensional point gₖ has at least two sources, including the uncertainty in the depth image intensity, which translates to uncertainty along the depth axis, and the uncertainty in feature point detection and matching in the texture image, which translates to uncertainty along the imaging plane.

Assuming a pinhole, no-skew projection model for the depth camera, Eq. (25) may be obtained.

$${z}_{k} [ \begin{matrix}{u}_{k} \\ {v}_{k} \\ 1\end{matrix} ] = {Kg}_{k} = [ \begin{matrix}{f}_{x} & 0 & {u}_{0} \\ 0 & {f}_{y} & {v}_{0} \\ 0 & 0 & 1\end{matrix} ] [ \begin{matrix}{x}_{k} \\ {y}_{k} \\ {z}_{k}\end{matrix} ] \qquad ( 25 )$$

According to eq. (25), vₖ=[uₖ, vₖ]^{T} is the two-dimensional image coordinate of the feature point k in the depth image, and gₖ=[xₖ,yₖ,zₖ]^{T} is the three-dimensional world coordinate of the feature point. In addition, K is the intrinsic matrix, where fₓ and f_{y} are the focal lengths, and u₀ and v₀ are the center biases.

For the depth camera, the uncertainty of uₖ and vₖ is generally caused by feature point uncertainties in the texture image, and the uncertainty in zₖ is due to the depth derivation scheme. These two uncertainties can be considered as independent of each other. Let cₖ=[uₖ,vₖ,zₖ]^{T}. Eq. (26) may then be obtained as shown below.

$${Σ}_{{c}_{k}} = [ \begin{matrix}{Σ}_{{v}_{k}} & 0 \\ {0}^{T} & {σ}_{{z}_{k}}^{2}\end{matrix} ] \qquad ( 26 )$$

From Eq. (26), Eq. (27) may be obtained.

$${G}_{k} {=}^{Δ} \frac{{\partial }_{{g}_{k}}}{{\partial }_{{c}_{k}}} = [ \begin{matrix}\frac{{z}_{k}}{{f}_{x}} & 0 & \frac{{u}_{k} - {u}_{0}}{{f}_{x}} \\ 0 & \frac{{z}_{k}}{{f}_{y}} & \frac{{v}_{k} - {v}_{0}}{{f}_{y}} \\ 0 & 0 & 1\end{matrix} ] \qquad ( 27 )$$

Hence, as an approximation, the sensor's noise covariance matrix may be defined according to Eq. (28).

Σₓ_{ₖ}≈GₖΣ_{c}_{ₖ}Gₖ^{T} (28)

In the current implementation, to compute Σ_{c}_{ₖ} from Eq. (26), it may be assumed that Σᵥ_{ₖ} is diagonal, i.e., Σᵥ_{ₖ}=σ²I₂, where I₂ is the 2×2 identity matrix, and σ=1.0 pixels. Knowing that the depth sensor derives depth based on triangulation, following Eq. (24), the depth image noise covariance σ_{z}_{ₖ}² may be modeled as shown below in Eq. (29).

$${σ}_{{z}_{k}}^{2} = \frac{{σ}_{0}^{2} {z}_{k}^{4}}{{f}_{d}^{2} {B}^{2}} \qquad ( 29 )$$

In Eq. (29),

$${f}_{d} = \frac{{f}_{x} + {f}_{y}}{2}$$

is the depth camera's average focal length; σ₀=0.059 pixels; and B=52.3875 millimeters based on calibration. Since σ_{z}_{ₖ} depends on zₖ, its value depends on each pixel's depth value and cannot be predetermined.

It is to be understood that the model tracking and fitting procedure 302 of FIG. 3 may be performed using any variation of the techniques described above. For example, the conditions and equations described above with respect to the model tracking and fitting procedure 302 may be modified based on the details of the specific implementation of the model based video projection technique 300.

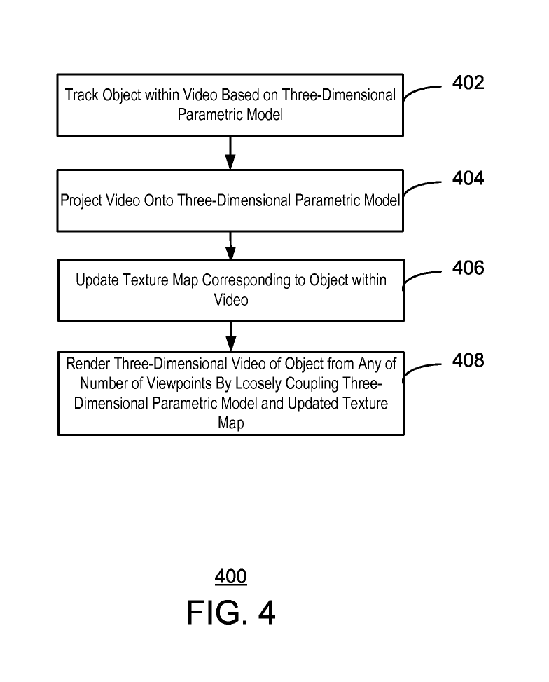

FIG. 4 is a process flow diagram showing a method 400 for model based video projection. In various embodiments, the method 400 is executed by a computing device. For example, the method 400 may be implemented within the networking environment 100 and/or the computing environment 200 discussed above with respect to FIGS. 1 and 2, respectively.

The method begins at block 402, at which an object within a video is tracked based on a three-dimensional parametric model. The video may be obtained from a physical camera. For example, the video may be obtained from a camera that is coupled to the computing device that is executing the method 400, or may be obtained from a remote camera via a network. The three-dimensional parametric model may be generated based on data relating to various objects of interest. For example, the parametric model may be a generic face model that is generated based on data relating to a human face.

The object may be any object within the video that has been designated as being of interest to a user of the computing device, for example. In various embodiments, the user may specify the type of object that is to be tracked, and an appropriate three-dimensional parametric model may be selected accordingly. In other embodiments, the three-dimensional parametric model automatically determines and adapts to the object within the video.

In various embodiments, the object within the video is tracked by aligning the three-dimensional parametric model with the object within the video. The three-dimensional parametric model may then be deformed to fit the video. In some embodiments, if one or more depth maps (or three-dimensional points clouds) corresponding to the video are available, the three-dimensional parametric model is deformed to fit the video and the one or more depth maps. The one or more depth maps may include images that contain information relating to the distance from the viewpoint of the camera that captured the video to the surface of the object within the scene. In addition, tracking the object within the video may include determining parameters for the three-dimensional parametric model based on data corresponding to the object within the video.

At block 404, the video is projected onto the three-dimensional parametric model. At block 406, a texture map corresponding to the object within the video is updated. The texture map may be updated by mapping the object within the video to the texture map. This may be accomplished by updating regions of the texture map corresponding to the object that are observed from the video. Thus, the texture map may be updated such that the object within the video is closely represented by the texture map.

At block 408, a three-dimensional video of the object is rendered from any of a number of viewpoints by loosely coupling the three-dimensional parametric model and the updated texture map. For example, the three-dimensional video may be rendered from a viewpoint specified by the user of the computing device. The three-dimensional video may then be used for any of a variety of applications, such as video conferencing applications or gaming applications.

In various embodiments, loosely coupling the three-dimensional parametric model and the updated texture map includes allowing the three-dimensional parametric model to not fully conform to the texture of the texture map. For example, if the object is a human face, the mouth region may be flat and not follow the texture of the lips and teeth within the texture map very closely. This may result in a higher quality visual representation of the object than is achieved when a more complex model is inferred from the video. Moreover, the three-dimensional parametric model may be simple, e.g., may not include very many parameters. Thus, strict coupling between the three-dimensional parametric model and the texture map may not be achievable. The degree of coupling that is achieved between the three-dimensional parametric model and the texture map may vary depending on the details of the specific implementation. For example, the degree of coupling may vary based on the complexity of the three-dimensional parametric model and the complexity of the object being tracked.

The process flow diagram of FIG. 4 is not intended to indicate that the method 400 is to include all of the steps shown in FIG. 3, or that all of the steps are to be executed in any particular order. Further, any number of additional steps not shown in FIG. 4 may be included within the method 400, depending on the details of the specific implementation. For example, the texture map may be updated based on the object within the video over a specified period of time, and the updated texture map may be used to render the three-dimensional video of the object from any specified viewpoint at any point in time. In addition, texture information relating to the updated texture map may be stored as historical texture information and used to render the object or a related object at some later point in time.

Further, if the tracked object is an individual's face, blending between the three-dimensional parametric model corresponding to the object and the remaining real-time captured video information corresponding to the rest of the body may be performed. In various embodiments, blending between the three-dimensional parametric model corresponding to the object and the video information corresponding to the rest of the body may allow for rendering of the entire body of the individual, with an emphasis on the face of the individual. In this manner, the individual's face may be viewed in context within the three-dimensional video, rather than as a disconnected object.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for model based video projection, comprising:
tracking an object within a video based on a three-dimensional parametric model via a computing device;
projecting the video onto the three-dimensional parametric model;
updating a texture map corresponding to the object within the video; and
rendering a three-dimensional video of the object from any of a plurality of viewpoints by loosely coupling the three-dimensional parametric model and the updated texture map.

2. The method of claim 1, wherein tracking the object within the video comprises aligning the three-dimensional parametric model with the object within the video.

3. The method of claim 1, wherein tracking the object within the video comprises deforming the three-dimensional parametric model to fit the video.

4. The method of claim 1, wherein tracking the object within the video comprises deforming the three-dimensional parametric model to fit the video and a depth map corresponding to the video.

5. The method of claim 1, wherein tracking the object within the video comprises determining parameters for the three-dimensional parametric model based on data corresponding to the object within the video.

6. The method of claim 1, wherein updating the texture map comprises mapping the object within the video to the texture map by updating regions of the texture map corresponding to the object that are observed from the video.

7. The method of claim 1, wherein rendering the three-dimensional video from any of the plurality of viewpoints comprises rendering the three-dimensional video from a viewpoint specified by a user of the computing device.

8. The method of claim 1, comprising:
updating the texture map based on the object within the video over a specified period of time; and
using the updated texture map to render the three-dimensional video of the object from any specified viewpoint at any point in time.

9. The method of claim 1, comprising using the three-dimensional video for a video conferencing application.

10. The method of claim 1, comprising using the three-dimensional video for a gaming application.

11. A system for model based video projection, comprising:
a processor that is configured to execute stored instructions; and
a system memory, wherein the system memory comprises code configured to:
track an object within a video by deforming a three-dimensional parametric model to fit the video;
project the video onto the three-dimensional parametric model;
update a texture map corresponding to the object within the video by updating regions of the texture map that are observed from the video; and
render a three-dimensional video of the object from any of a plurality of viewpoints by loosely coupling the three-dimensional parametric model and the updated texture map.

12. The system of claim 11, wherein the object within the video comprises a face.

13. The system of claim 11, wherein the system memory comprises code configured to track the object within the video by deforming the three-dimensional parametric model to fit the video and a depth map corresponding to the video.

14. The system of claim 11, wherein the system memory comprises code configured to render the three-dimensional video from a viewpoint specified by a user of the system.

15. The system of claim 11, wherein the processor is configured to send the three-dimensional video of the object to a video conferencing application.

16. The system of claim 11, wherein the processor is configured to send the three-dimensional video of the object to a gaming application.

17. The system of claim 11, wherein the processor is configured to:
store the updated texture map within the system memory; and
use the updated texture map to render the three-dimensional video of the object from any specified viewpoint at any point in time.

18. One or more computer-readable storage media comprising a plurality of instructions that, when executed by a processor, cause the processor to:
track an object within a video based on a three-dimensional parametric model;
project the video onto the three-dimensional parametric model;
update a texture map corresponding to the object within the video; and
render a three-dimensional video of the object from any of a plurality of viewpoints by loosely coupling the three-dimensional parametric model and the updated texture map.

19. The one or more computer-readable storage media of claim 18, wherein the instructions cause the processor to track the object within the video by deforming the three-dimensional parametric model to fit the video and a depth map corresponding to the video.

20. The one or more computer-readable storage media of claim 18, wherein the instructions cause the processor to use the updated texture map to render the three-dimensional video of the object from any specified viewpoint at any point in time.
